(19) United States
(12) Patent Application Publication
(10) Pub. No.: US 2017/0201662 A1
(43) Pub. Date: Jul. 13, 2017

(54) ELECTRONIC DEVICE FOR PROVIDING THERMAL IMAGE AND METHOD THEREOF

(71) Applicant: Samsung Electronics Co., Ltd., Gyeonggi-do (KR)

(72) Inventors: Dongsoo KIM, Gyeonggi-do (KR); Hwayong Kang, Gyeonggi-do (KR); Donghoon Jang, Gyeonggi-do (KR); Jaeoh Jeong, Gyeonggi-do (KR); Jonghoon Won, Gyeonggi-do (KR); Kihuk Lee, Gyeonggi-do (KR)

(73) Assignee: Samsung Electronics Co., Ltd.

(21) Appl. No.: 15/401,837

(22) Filed: Jan. 9, 2017

(30) Foreign Application Priority Data
Jan. 7, 2016 (KR) 10-2016-0002168

(51) Int. Cl. H04N 5/225; H04N 9/09; H04N 5/232; H04N 5/33

(52) U.S. Cl. CPC H04N 5/2258; H04N 5/33; H04N 9/09; H04N 5/2253; H04N 5/23229; H04N 5/23293; H04N 5/23258

(57) ABSTRACT

An electronic device is provided. The electronic device includes a display, an image sensor including a color pixel sensor, a thermal image sensor, and a processor configured to acquire a first image of a subject using the color pixel sensor, acquire a second image of the subject using the thermal image sensor, and replace a part of an area of the first image with the second image thereby creating an modified first image that is output through the display.

### PRIORITY

This application claims priority under 35 U.S.C. §119(a) to Korean Patent Application Serial No. 10-2016-0002168, which was filed in the Korean Intellectual Property Office on Jan. 7, 2016, the entire content of which is incorporated herein by reference.

### BACKGROUND

1. Field of the Disclosure

The present disclosure relates generally to an electronic device, and more particularly, to an electronic device including both a color pixel sensor and a thermal image sensor for providing a thermal image and a method thereof.

2. Description of the Related Art

Conventional camera devices can be configured to process an image acquired through an image sensor; and some electronic devices can be configured for controlling a functionality of other electronic devices. The electronic devices may have an image sensor(s) that allow the electronic device to provide a photographing function, in addition to a communication function and a message transmission/reception function. Furthermore, recent electronic devices may provide a thermal imaging function that detects infrared or far-infrared rays radiated from a subject so as to detect temperature data of the subject.

However, the limited space that is typically present within conventional electronic devices makes mounting the one or more modules or components that are required for obtaining a thermal image problematic.

### SUMMARY

An aspect of the present disclosure provides a thermal image through an image sensor including a thermal image sensor, which provides both a color image and a thermal image through an image sensor.

In accordance with an aspect of the present disclosure, there is provided an electronic device. The electronic device includes a display, an image sensor including a color pixel sensor, a thermal image sensor, and a processor configured to acquire a first image of a subject using the color pixel sensor, acquire a second image of the subject using the thermal image sensor, and replace a part of an area of the first image with the second image thereby creating an modified first image that is output through the display.

In accordance with an aspect of the present disclosure, there is provided a method of an electronic device that comprises a display, a color pixel sensor, a thermal image sensor, and a processor. The method includes acquiring a first image of a subject using the color pixel sensor, acquiring a second image of the subject using the thermal image sensor, and replacing a part of an area of the first image with the second image thereby creating a modified first image and outputting the same through the display, using the processor.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram of a network environment system, according to an embodiment of the present disclosure;

FIG. 2 is a block diagram of an electronic device, according to an embodiment of the present disclosure;

FIG. 3 is a block diagram of a programming module, according to an embodiment of the present disclosure;

FIG. 4 is a block diagram of an electronic device, according to an embodiment of the present disclosure;

FIG. 5 is a diagram of an image sensor in an electronic device, according to an embodiment of the present disclosure;

FIG. 6 is a perspective view of an image sensor in an electronic device, according to an embodiment of the present disclosure;

FIG. 7 is a cross-sectional view taken along the line I-I′ of FIG. 6, according to an embodiment of the present disclosure;

FIG. 8 is a diagram of an image sensor, according to an embodiment of the present disclosure;

FIG. 9 is a flowchart of a method of use of an electronic device, according to an embodiment of the present disclosure;

FIG. 10 to FIG. 12 are diagrams of an image acquired through an electronic device, according to an embodiment of the present disclosure; and

FIG. 13 is a flowchart of a method of use of an electronic device according to an embodiment of the present disclosure.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example,

“A or B,” “at least one of A and B,” or “at least one of A or B” means (1) including at least one A, (2) including at least one B, or (3) including both at least one A and at least one B.

The terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. For example, a first element may be referred to as a second element without departing from the scope the present invention, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “ adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a general-purpose processor (e.g., a CPU or an application processor) capable of performing a corresponding operation by executing one or more software programs stored in a memory device.

The term “module” as used herein may be defined as, for example, a unit including one of hardware, software, and firmware or two or more combinations thereof. The term “module” may be interchangeably used with, for example, the terms “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

The terms used in describing the various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding embodiments of the present disclosure.

Electronic devices according to the embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to an embodiment of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™), electronic dictionaries, electronic keys, camcorders, or electronic picture frames.

The electronic devices may include at least one of various medical devices (e.g., various portable medical measurement devices (such as blood glucose meters, heart rate monitors, blood pressure monitors, or thermometers, and the like), a magnetic resonance angiography (MRA) device, a magnetic resonance imaging (MRI) device, a computed tomography (CT) device, scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller machines (ATMs), points of sales (POSs) devices, or Internet of Things (IoT) devices (e.g., light bulbs, various sensors, electric or gas meters, sprinkler devices, fire alarms, thermostats, street lamps, toasters, exercise equipment, hot water tanks, heaters, boilers, and the like).

The electronic devices may further include at least one of parts of furniture or buildings/structures, electronic boards, electronic signature receiving devices, projectors, or various measuring instruments (such as water meters, electricity meters, gas meters, or wave meters, and the like). The electronic devices may be one or more combinations of the above-mentioned devices. The electronic devices may be flexible electronic devices. Also, the electronic devices are not limited to the above-mentioned devices, and may include new electronic devices according to the development of new technologies.

Hereinafter, the electronic devices according to various embodiments of the present disclosure will be described with reference to the accompanying drawings. The term “user” as used herein may refer to a person who uses an electronic device or may refer to a device (e.g., an artificial intelligence electronic device) which uses an electronic device.

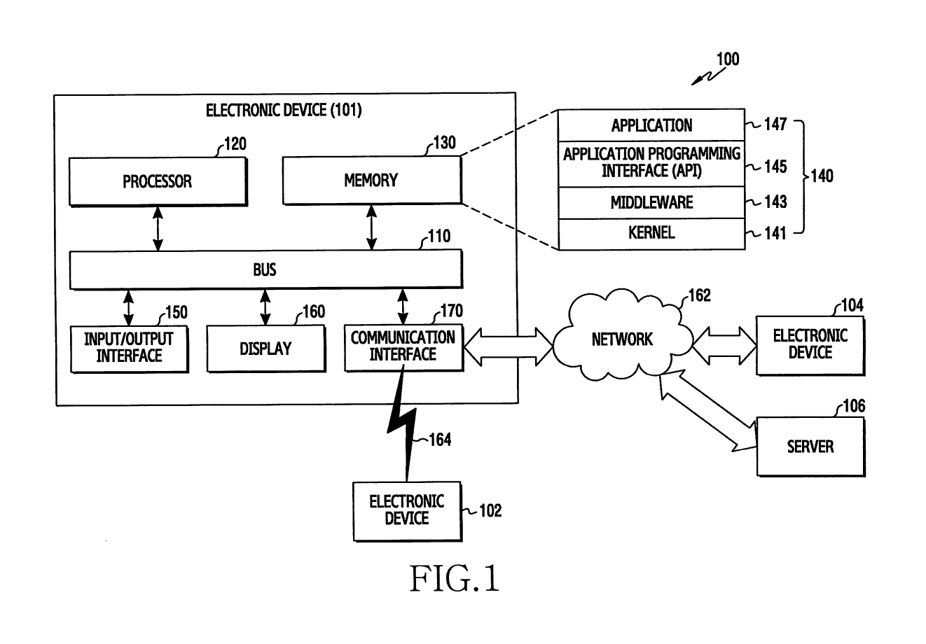

Referring to FIG. 1, an electronic device 101 within a network environment 100 according to an embodiment of the present disclosure is illustrated. The electronic device 101 includes a bus 110, a processor 120, a memory 130, an input/output interface 150, a display 160, and a communication interface 170. The electronic device 101 may omit at least one of the elements, or may further include other elements. The bus 110 may include a circuit that interconnects the elements 110 to 170 and transfers communication (e.g., control messages and/or data) between the elements. The processor 120 may include one or more of a central processing unit, an application processor, and a communication processor (CP). The processor 120 may carry out operations or data processing relating to the control and/or communication of at least one other element of the electronic device 101.

The memory 130 may include a volatile and/or non-volatile memory. The memory 130 may store instructions or data relevant to at least one other element of the electronic device 101. The memory 130 may store software and/or a program 140. The program 140 may include a kernel 141, middleware 143, an application programming interface (API) 145, and/or application programs (or “applications”) 147. At least a part of the kernel 141, the middleware 143, or the API 145 may be referred to as an operating system (OS). The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access the individual elements of the electronic device 101 to control or manage the system resources.

The middleware 143 may function as an intermediary for allowing the API 145 or the application programs 147 to communicate with the kernel 141 to exchange data. Furthermore, the middleware 143 may process one or more task requests, which are received from the application programs 147, according to priorities thereof. For example, the middleware 143 may assign priorities for using the system resources (e.g., the bus 110, the processor 120, the memory 130, etc.) of the electronic device 101 to one or more of the application programs 147, and may process the one or more task requests. The API 145 is an interface used by the applications 147 to control a function provided from the kernel 141 or the middleware 143, and may include at least one interface or function (e.g., instruction) for file control, window control, image processing, text control, etc. For example, the input/output interface 150 may forward instructions or data, which is input from a user or an external device, to the other element(s) of the electronic device 101, or may output instructions or data, which is received from the other element(s) of the electronic device 101, to the user or the external device.

The display 160 may include a liquid crystal display (LCD), a light emitting diode (LED) display, an organic light emitting diode (OLED) display, a micro electro mechanical system (MEMS) display, or an electronic paper display. The display 160 may display various types of content (e.g., text, images, videos, icons, and/or symbols) for a user. The display 160 may include a touch screen and may receive a touch, gesture, proximity, or hovering input using an electronic pen or the user's body part.

The communication interface 170 may configure communication between the electronic device 101 and a first external electronic device 102, a second external electronic device 104, or a server 106. For example, the communication interface 170 may be connected to a network 162 through wireless or wired communication to communicate with the second external electronic device 104 or the server 106.

The wireless communication may include a cellular communication that uses at least one of long term evolution (LTE_, LTE-Advance (LTE-A), code division multiple access (CDMA), wideband CDMA (WCDMA), universal mobile telecommunications system (UMTS), wireless broadband (WiBro), global system for mobile communications (GSM), etc. The wireless communication may include at least one of wireless fidelity (WiFi), bluetooth (BT), BT low energy (BLE), ZigBee, near field communication (NFC), magnetic secure transmission, radio frequency (RF), and body area network (BAN). The wired communication may include GNSS. The GNSS may be a global positioning system (GPS), a global navigation satellite system (Glonass), a Beidou Navigation Satellite System (Beidou), or Galileo (the European global satellite-based navigation system). Hereinafter, in the present document, “GPS” may be used interchangeably with “GNSS”. The wired communication may include at least one of a universal serial bus (USB), a high definition multimedia interface (HDMI), recommended standard 232 (RS-232), a power line communication, and a plain old telephone Service (POTS). The network 162 may include a telecommunications network at least one of a computer network (e.g., a local area network (LAN) or a wide area network (WAN)), the Internet, and a telephone network.

Each of the first and second external electronic devices 102 and 104 may be of a type identical to or different from that of the electronic device 101. All or some of the operations executed in the electronic device 101 may be executed in another electronic device or in the electronic devices 102 and 104 or the server 106. When the electronic device 101 has to perform some functions or services automatically or in response to a request, the electronic device 101 may request the electronic device 102 or 104 or the server 106 to perform at least some functions relating thereto instead of, or in addition to, performing the functions or services by itself. The other electronic device 102 or 104 or the server 106 may perform the requested functions or the additional functions and may transfer the execution result to the electronic device 101. The electronic device 101 may provide the received result as it is, or may additionally process the received result to provide the requested functions or services. To this end, for example, cloud computing, distributed computing, or client-server computing technology may be used.

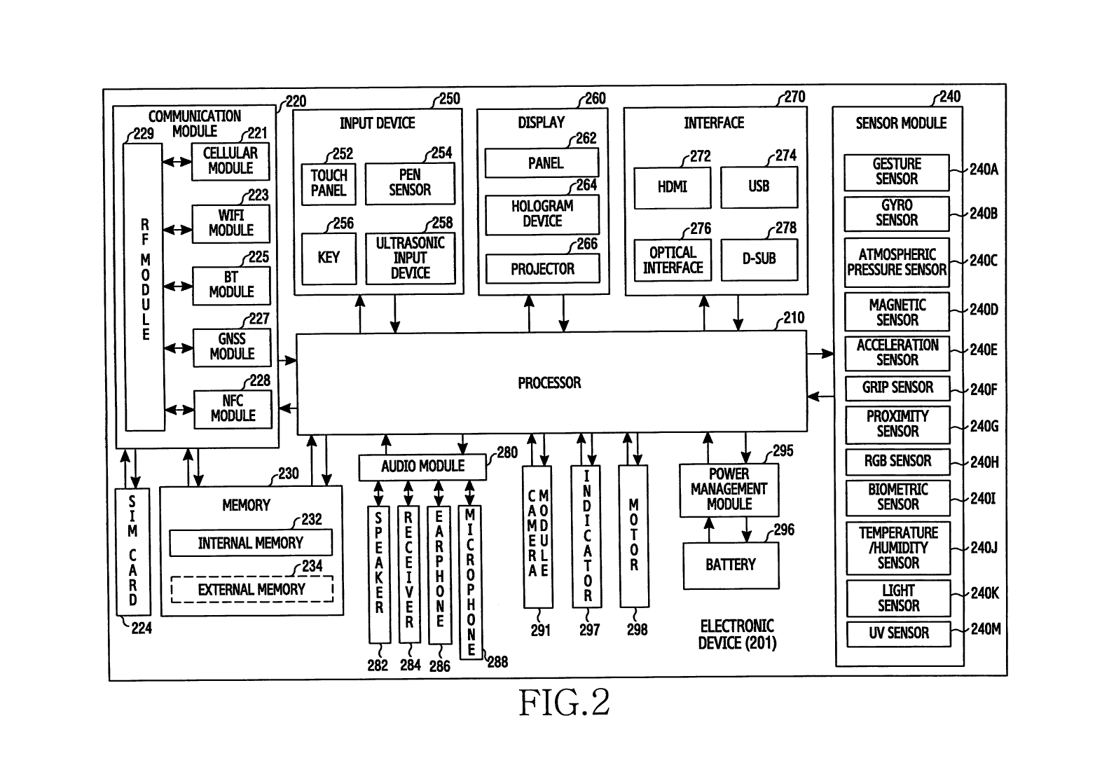

FIG. 2 is a block diagram of an electronic device 201, according to an embodiment of the present disclosure. The electronic device 201 may include some or all of the components of the electronic device 101 illustrated in FIG. 1. The electronic device 201 includes at least one processor 210 (e.g., an AP), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 may control a plurality of hardware or software elements connected thereto and may perform various data processing and operations by driving an operating system or an application program. The processor 210 may be embodied as a system on chip (SoC). The processor 210 may further include a graphic processing unit (GPU) and/or an image signal processor. The processor 210 may also include at least some (for example, a cellular module 221) of the elements illustrated in FIG. 2. The processor 210 may load, in a volatile memory, instructions or data received from at least one of the other elements (e.g., a non-volatile memory), process the loaded instructions or data, and store the result data in the non-volatile memory.

The communication module 220 may have a configuration that is the same as or similar to that of the communication interface 170. The communication module 220 may include a cellular module 221, a Wi-Fi module 223, a BT module 225, a GNSS module 227, an NFC module 228, and an RF module 229. The cellular module 221 may provide a voice call, a video call, a text message service, an Internet service, etc. through a communication network. The cellular module 221 may identify and authenticate the electronic device 201 within a communication network using the SIM 224 (for example, a SIM card). The cellular module 221 may perform at least some of the functions that the processor 210 may provide. The cellular module 221 may include a CP. At least some (for example, two or more) of the cellular module 221, the Wi-Fi module 223, the BT module 225, the GNSS module 227, and the NFC module 228 may be included in one integrated chip (IC) or IC package.

The RF module 229 may transmit or receive a communication signal (for example, an RF signal). The RF module 229 may include a transceiver, a power amp module (PAM), a frequency filter, a low noise amplifier (LNA), an antenna, etc. At least one of the cellular module 221, the Wi-Fi module 223, the BT module 225, the GNSS module 227, and the NFC module 228 may transmit or receive an RF signal through a separate RF module.

The SIM 224 may be an embedded SIM, and may include unique identification information (e.g., an integrated circuit card identifier (ICCID)) or subscriber information (e.g., international mobile subscriber identity (IMSI)).

The memory 230 may include an embedded memory 232 or an external memory 234. The embedded memory 232 may include at least one of a volatile memory (e.g., a dynamic read access memory (DRAM), a static RAM (SRAM), an SDRAM, etc.) and a non-volatile memory (e.g., a one time programmable read only memory (OTPROM), a programmable ROM (PROM), an erasable and programmable (EPROM), an electrically erasable and programmable ROM (EEPROM), a mask ROM, a flash ROM, a flash memory, a hard disc drive, or a solid state drive (SSD)). The external memory 234 may include a flash drive a compact flash (CF), a secure digital (SD), a micro-SD, a mini-SD, an eXtreme digital (xD), a multi-media card (MMC), a memory stick, etc. The external memory 234 may be functionally or physically connected to the electronic device 201 through various interfaces.

The sensor module 240 may measure a physical quantity or detect the operating state of the electronic device 201 and may convert the measured or detected information into an electrical signal. The sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 2406, a color sensor 240H (for example, a red, green, blue (RGB) sensor), a biometric sensor 2401, a temperature/humidity sensor 240J, a light sensor 240K, and a ultraviolet (UV) sensor 240M. Additionally or alternatively, the sensor module 240 may include an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. The electronic device 201 may further include a processor, which is configured to control the sensor module 240, as a part of the processor 210 or separately from the processor 210 in order to control the sensor module 240 while the processor 210 is in a sleep state.

The input device 250 may include a touch panel 252, a (digital) pen sensor 254, a key 256, or an ultrasonic input device 258. The touch panel 252 may use at least one of a capacitive type, a resistive type, an infrared type, and an ultrasonic type. Furthermore, the touch panel 252 may further include a control circuit. The touch panel 252 may further include a tactile layer to provide a tactile reaction to a user. The touch panel 252 may include a pressure sensor (or a force sensor) which may measure a strength of pressure of a touch by a user.

The pressure sensor may be integrated with the touch panel 252 or may be implemented as one or more sensors separated from the touch panel 252. The (digital) pen sensor 254 may include a recognition sheet that is a part of, or separate from, the touch panel. The key 256 may include a physical button, an optical key, or a keypad. The ultrasonic input device 258 may detect ultrasonic waves, which are generated by an input tool, through a microphone 288 to identify data corresponding to the detected ultrasonic waves.

The display 260 may include a panel 262, a hologram device 264, a projector 266, and/or a control circuit for controlling them. The panel 262 may be implemented to be flexible, transparent, or wearable. The panel 262, together with the touch panel 252, may be configured as one or more modules. The hologram device 264 may show a three dimensional image in the air by using an interference of light. The projector 266 may display an image by projecting light onto a screen. The screen may be located in the interior of, or on the exterior of, the electronic device 201. The interface 270 may include an HDMI 272, a USB 274, an optical interface 276, or a d-subminiature (D-sub) 278. The interface 270 may be included in the communication interface 170 illustrated in FIG. 1. Additionally or alternatively, the interface 270 may include a mobile high-definition link (MHL) interface, an SD card/multi-media Card (MMC) interface, or an infrared data association (IrDA) standard interface.

The audio module 280 may convert a sound into an electrical signal, and vice versa. At least some elements of the audio module 280 may be included in the input/output interface 145 illustrated in FIG. 1. The audio module 280 may process sound information that is input or output through a speaker 282, a receiver 284, earphones 286, the microphone 288, etc.

The camera module 291 is a device that can photograph a still image and a moving image. The camera module 291 may include one or more image sensors (e.g., a front sensor or a rear sensor), a lens, an image signal processor (ISP), or a flash (e.g., an LED or xenon lamp).

The power management module 295 may manage the power of the electronic device 201. The power management module 295 may include a power management integrated circuit (PMIC), a charger IC, or a battery gauge. The PMIC may have a wired and/or wireless charging method. Examples of the wireless charging method may include a magnetic resonance method, a magnetic induction method, an electromagnetic wave method, etc. Additional circuits (for example, a coil loop, a resonance circuit, a rectifier, etc.) for wireless charging may be further included. The battery gauge may measure a residual quantity of the battery 296, and a voltage, a current, or a temperature while charging. The battery 296 may include a rechargeable battery and/or a solar battery.

The indicator 297 may indicate a particular state (for example, a booting state, a message state, a charging state, and the like) of the electronic device 201 or a part (for example, the processor 210) thereof.

The motor 298 may convert an electrical signal into a mechanical vibration and may generate a vibration, a haptic effect, etc. The electronic device 201 may include a mobile TV support device that can process media data according to a standard, such as digital multimedia broadcasting (DMB), digital video broadcasting (DVB), MediaFlo™, etc. Each of the above-described component elements of hardware may be configured with one or more components, and the names of the corresponding component elements may vary based on the type of electronic device. The electronic device 201 may omit some elements or may further include additional elements, or some of the elements of the electronic device may be combined with each other to configure one entity, in which case the electronic device 201 may identically perform the functions of the corresponding elements prior to the combination.

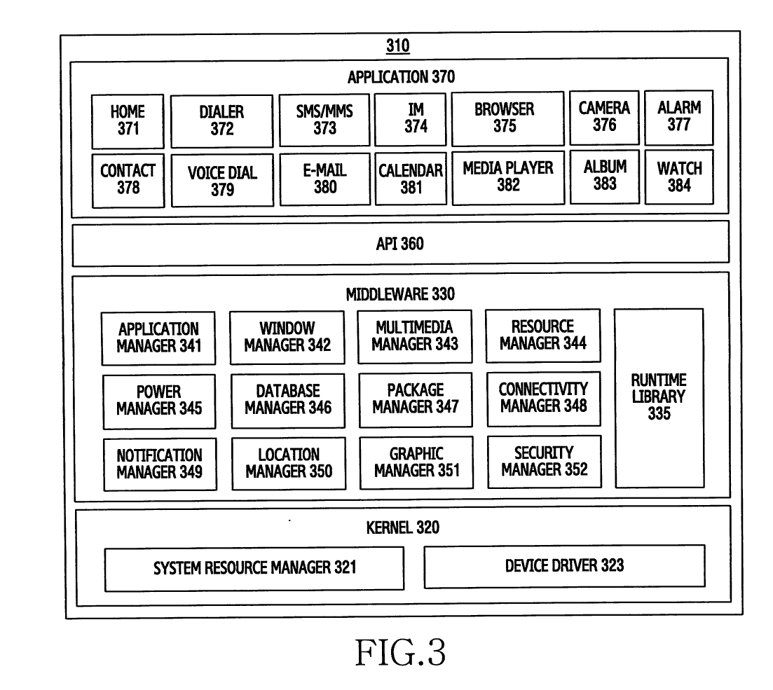

FIG. 3 is a block diagram of a program module, according to an embodiment of the present disclosure. The program module 310 may include an OS that controls resources relating to the electronic device 101 and/or various applications (e.g., the application programs 147) that are driven on the OS. The OS may include Android™, iOS™, Windows™, Symbian™, Tizen™, or Bada™.

Referring to FIG. 3, the program module 310 includes a kernel 320, middleware 330, an API 360, and/or applications 370. At least a part of the program module 310 may be preloaded on the electronic device 101, or may be downloaded from the electronic device 102 or 104 or the server 106.

The kernel 320 may include a system resource manager 321 and/or a device driver 323. The system resource manager 321 may control, allocate, or retrieve system resources. The system resource manager 321 may include a process manager, a memory manager, or a file system manager. The device driver 323 may include a display driver, a camera driver, a BT driver, a shared memory driver, a USB driver, a keypad driver, a Wi-Fi driver, an audio driver, or an inter-process communication (IPC) driver. For example, the middleware 330 may provide a function required by the applications 370 in common, or may provide various functions to the applications 370 through the API 360 to enable the applications 370 to use the limited system resources within the electronic device. The middleware 330 may include at least one of a runtime library 335, an application manager 341, a window manager 342, a multi-media manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the applications 370 are being executed. The runtime library 335 may manage an input/output, manage a memory, or process an arithmetic function. The application manager 341 may manage the life cycles of the applications 370. The window manager 342 may manage GUI resources used for a screen. The multimedia manager 343 may identify formats required for reproducing various media files and may encode or decode a media file using a codec suitable for the corresponding format. The resource manager 344 may manage the source codes of the applications 370 or the space of a memory. The power manager 345 may manage the capacity or power of a battery and may provide power information required for operating the electronic device. The power manager 345 may operate in conjunction with a basic input/output system (BIOS). The database manager 346 may generate, search, or change databases to be used by the applications 370. The package manager 347 may manage the installation or update of an application that is distributed in the form of a package file.

The connectivity manager 348 may manage wireless connection. The notification manager 349 may provide an event (e.g., an arrival message, an appointment, a proximity notification, etc.) to a user. The location manager 350 may manage the location information of the electronic device. The graphic manager 351 may manage a graphic effect to be provided to a user, or a user interface relating thereto. The security manage 352 may provide system security or user authentication. The middleware 330 may include a telephony manager for managing a voice or video call function of the electronic device or a middleware module that is capable of forming a combination of the functions of the above-described elements. The middleware 330 may provide specialized modules according to the types of operation systems. The middleware 330 may dynamically remove some of the existing elements, or may add new elements. The API 360 is a set of API programming functions, and may be provided with different configurations according to operating systems. For example, in the case of Android™ or iOS™, each platform may be provided with one API set, and in the case of Tizen™, each platform may be provided with two or more API sets.

The applications 370 may include one or more applications that can perform functions, such as home application 371, a dialer application 372, an SMS/MMS application 373, an instant message application (IM) 374, a browser application 375, a camera application 376, an alarm application 377, a contacts application 378, a voice dial application 379, an e-mail application 380, a calendar application 381, a media player application 382, an album application 383, a watch application 384, a health care application (e.g., measuring exercise quantity or blood glucose level), providing of environment information (e.g., atmospheric pressure, humidity, or temperature information), and the like.

The applications 370 may include an information exchange application that can support the exchange of information between the electronic device 101 and an external electronic devices 102, 104. The information exchange application may include a notification relay application for relaying particular information to an external electronic device or a device management application for managing an external electronic device. For example, the notification relay application may relay notification information generated in the other applications of the electronic device 101 to the external electronic devices 102, 104, or may receive notification information from the external electronic devices 102, 104 to provide the received notification information to a user. The device management application may install, delete, or update functions of the external electronic devices 102, 104 that communicates with the electronic device 101 (e.g., turning on/off the external electronic device itself (or some elements thereof) or adjusting the brightness (or resolution) of a display) or applications executed in the external electronic devices 102, 104. The applications 370 may include applications (e.g., a health care application of a mobile medical appliance) that are designated according to the attributes of an external electronic device. The applications 370 may include applications received from an external electronic device. At least a part of the program module 210 may be implemented (e.g., executed) by software, firmware, hardware (e.g., a processor 210), or a combination of one or more thereof, and may include, for performing at least one function, a module, a program, a routine, an instruction set, or a process.

At least some of devices (e.g., modules or functions thereof) or methods (e.g., operations) may be implemented by an instruction which is stored a non-transitory computer-readable storage medium (e.g., the memory 130) in the form of a program module. The instruction, when executed by a processor (e.g., the processor 120), may execute the function corresponding to the instruction. The non-transitory computer-readable storage medium may include a hard disk, a floppy disk, a magnetic medium (e.g., a magnetic tape), an optical media (e.g., CD-ROM, DVD), a magneto-optical media (e.g., a floptical disk), an embedded memory, etc. The instruction may include a code which is made by a compiler or a code which may be executed by an interpreter.

The electronic device including a display, a color pixel sensor, a thermal image sensor, and a processor may include a non-transitory computer-readable recording medium in which a program is recorded, the program when executed performs a method including acquiring a first image of a subject using the color pixel sensor, acquiring a second image of the subject using the thermal image sensor, and replacing a part of the area of the first image with the second image, thereby outputting the same through the display.

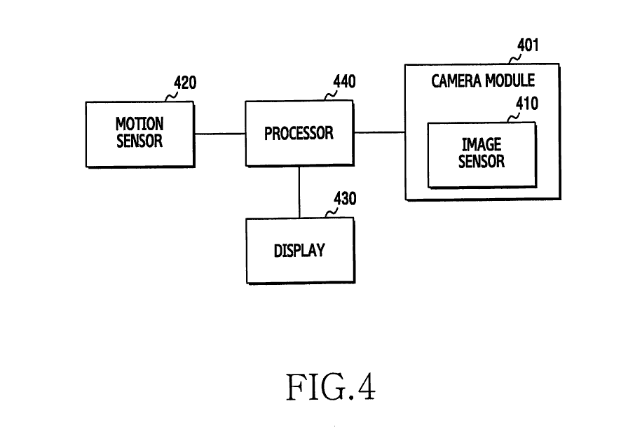

FIG. 4 is a block diagram of the electronic device 101, according to an embodiment of the present disclosure.

As illustrated in FIG. 4, the electronic device 101 includes a camera module 401, a motion sensor 420, a display 430, and a processor 440. The electronic device 101 may be an image processing device, and the electronic device 101 may provide a thermal image.

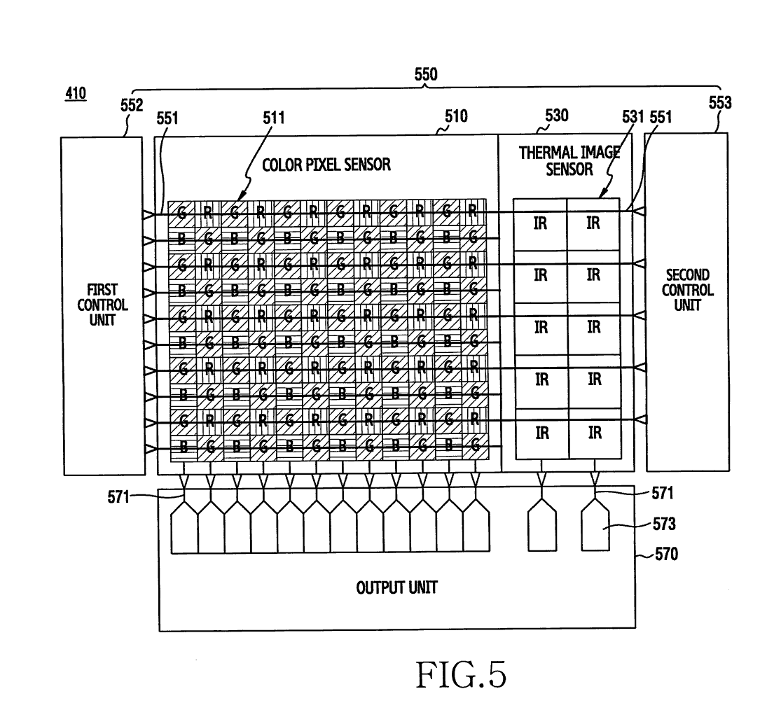

The camera module 401 is a device capable of photographing a still image or a video of a subject, and may include an image sensor 410, a thermal image sensor 530 (FIG. 5), a lens, an ISP, and the like. The image sensor 410 includes a color pixel sensor. The image sensor 410 may include the thermal image sensor 530. The image sensor 410 may acquire a color image corresponding to a subject through color information corresponding to the color pixel sensor. The image sensor 410 may acquire a thermal image through thermal image information corresponding to the thermal image sensor. The image sensor 410 may acquire the color image together with the thermal image at the same time. The image sensor 410 may provide the color image and the thermal image sensor 530 may provide thermal image information.

The motion sensor 420 may sense a motion of the electronic device 101. For example, the motion sensor 420 may include a motion detection sensor, the gesture sensor 240A, a geomagnetic sensor, the gyro sensor 240B, or the acceleration sensor 240E. The motion sensor 420 may sense the rotation angle, geomagnetic direction, or azimuth change of the electronic device 101.

The display 430 may display an image acquired through the image sensor 410. The display 430 may display an image processed through the processor 440. The display may display a color image or a thermal image. The display 430 may display a color image or a thermal image at the same time. The display 430 may display an image changing according to a motion of the electronic device 101. For example, the display 430 may display a procedure by which a color image is replaced with a thermal image according to the motion of the electronic device 101.

The processor 440 may process an image acquired through the image sensor 410. The processor 440 may process an image using the image acquired through the image sensor 410 and motion information acquired through the motion sensor 420. For example, the processor 440 may align a color image and a thermal image through the motion information. The processor 440 may have an ISP for image processing. Alternatively, the processor 440 and an ISP are separated from each other, and the ISP may process an image.

The processor 440 may further include a graphic processing module that outputs a color image or a thermal image on the display 430. The processor 440 may process an image output from the image sensor 410 so as to process the same into a preview image on the display 430, and process the image as a still image or a video image under the control of a user so as to store the same in a memory (for example, the memory 230 in FIG. 2).

Hereinafter, the image sensor 410 is described in detail with reference to FIG. 5.

The image sensor 410 includes a color pixel sensor 510, the thermal image sensor 530, a first control unit 552, a second control unit 553, and an output unit 570. The image sensor 410 may acquire an image corresponding to a subject. The image sensor 410 may acquire a first image 1011 corresponding to the subject through the color pixel sensor 510. For example, the image sensor 410 may acquire a color image corresponding to the subject through the color pixel sensor 510. The image sensor 410 may acquire a second image 1013 corresponding to the subject through the thermal image sensor 530. For example, the image sensor 410 may acquire a thermal image corresponding to the subject through the thermal image sensor 530.

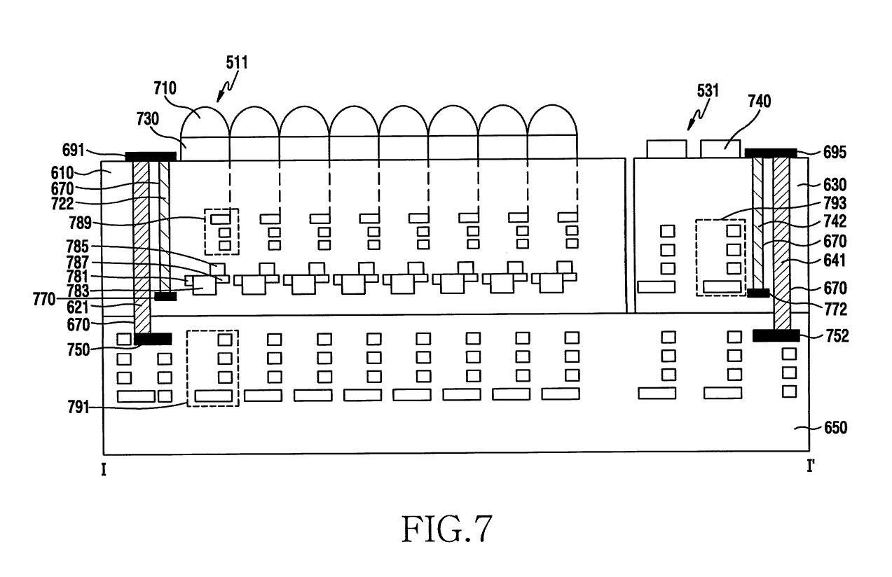

The color pixel sensor 510 may be a substrate including a color pixel array 511. The color pixel array 511 may include a plurality of color pixels. The color pixel array may acquire the amount of incident light. For example, the color pixel may include one or more microlenses (reference number 710 in FIG. 7), one or more color filters (reference number 730 in FIG. 7), and one or more photodiodes.

The thermal image sensor 530 may be a substrate including a thermal image pixel array 531, and may include a plurality of thermal image pixels. The thermal image pixel may sense infrared or far-infrared rays emitted from the subject. The thermal image pixels may detect temperature data by sensing the temperature distribution of the subject. The thermal image pixels may include, for example, a microbolometer sensor.

The control unit 550 may drive the color pixel sensor 510 and the thermal image sensor 530, and may control an input of the color pixel sensor 510 and the thermal image sensor 530. The control unit 550 may control input signals applied to the color pixel sensor 510 and the thermal image sensor 530. The control unit 550 may be a row decoder. The control unit 550 may apply, to the color pixel array 511 and the thermal image array 531, driving signals such as a selection signal, a reset signal, and a transmission signal through an input line 551 (for example, row signal lines). The control unit 550 may apply the driving signals to the color pixel array 511 and the thermal image array 531 by selecting line pixels of the color pixel array 511 and the thermal image array 531. The control unit 550 may include the first control unit 552 that drives the color pixel sensor 510 and the second control unit 553 for driving the thermal image sensor 530. The first control unit 552 that drives the color pixel sensor 510 may be disposed adjacent to the color pixel sensor 510. For example, the first control unit 552 may be disposed at the lower part of the color pixel sensor 510. In addition, the second control unit 553 that drives the thermal image sensor 530 may be disposed adjacent to the thermal image sensor 530. For example, the second control unit 553 may be disposed at the lower part of the thermal image sensor 530. In addition, the second control unit 553 may be implemented separated from the first control unit 550 that controls the color pixel sensor 510 in order to independently control the thermal image sensor 530, so as to independently control and drive the thermal image sensor 530.

However, the embodiment is not limited thereto, and the control unit 550 that drives the color pixel sensor 510 and the thermal image sensor 530 may be implemented in one control unit. The color pixel sensor 510 and the thermal image sensor 530 may share an identical input line 551. Therefore, one control unit 550 may be provided to control the color pixel sensor 510 and the thermal image sensor 530 at the same time.

The color pixel array 511 may output, to an output unit 570, pixel signals that are electrical signals sensed by the color pixels in response to respective driving signals of the control unit 550 through a plurality of output lines 571. For example, the output unit 570 may be a column readout and a digital circuit. The signal output according to a control signal of the control unit 550 may be provided to an analog-digital converter 573 (ADC 573). The ADC 573 may convert, to a digital signal, a color pixel signal provided by the color pixel array 511. The image sensor 410 may convert the amount of light acquired in the color pixel array 511 to color pixel data through the ADC 573. The color pixel data may be output through the output unit 570 including an image pipeline. The color pixel data may be transmitted, in the output unit 570, to the outside (for example, an image signal processor or an application processor) through an interface such as a mobile industry processor interface (MIPI).

The thermal image pixel array 531 may output, to an output unit 570, signals sensed by respective thermal image pixels in response to driving signals of the control unit 550. The signals output according to a control signal of the control unit 550 may be provided to the ADC 573. The ADC 573 may convert, to a digital signal, a thermal image pixel signal provided by the thermal image pixel array 531. The image sensor 410 may convert, to thermal image pixel data, infrared data acquired in the thermal image pixel array 531 through the ADC 573. The thermal image pixel data may be output through the output unit 570 including an image pipeline. The thermal image pixel data may be transmitted, in the output unit 570, to the outside (for example, an image signal processor or an application processor) through an interface such as an MIPI.

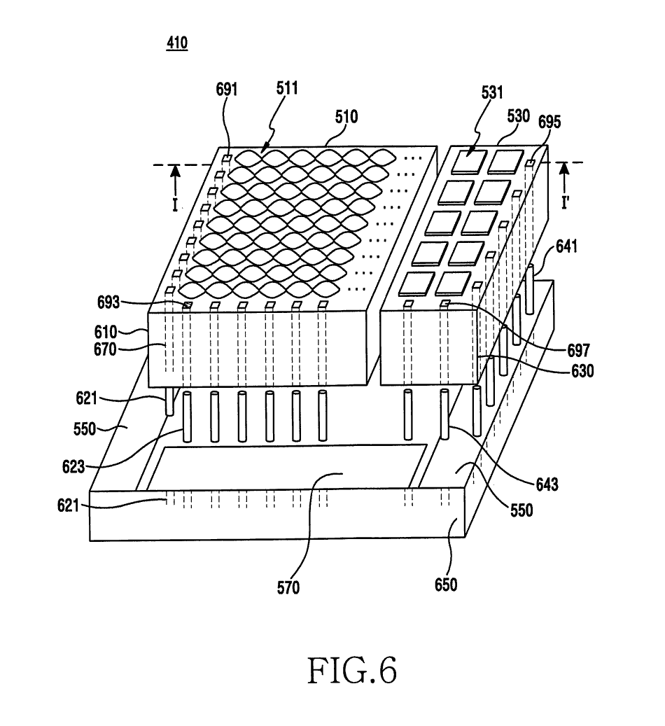

FIG. 6 is a perspective view of the image sensor 410 in an electronic device 101, and FIG. 7 is a cross-sectional view taken along the line I-I′ of FIG. 6.

As illustrated in FIG. 6, the color pixel sensor 510 may be configured or provided on a first substrate 610. The color pixel sensor 510 may include one or more microlenses 710, one or more color filters 730, one or more wirings 789, and one or more photodiodes, which are configured on the first substrate 610.

The first substrate 610 may be a semiconductor substrate, and may include an n-channel metal oxide semiconductor (NMOS) transistor and a p-channel metal oxide semiconductor (PMOS) transistor. The NMOS transistor may be formed in a P-type semiconductor substrate and the PMOS transistor may be formed in an N-type well in a P-type semiconductor substrate. A stacking structure may be formed by using a conventional semiconductor fabrication process for the first substrate 610. For example, a stacking structure may be formed using an ion implantation process, a patterning process, or a deposition process. Through this, the first substrate 610 may include various circuit elements.

For example, the first substrate 610 may be divided into an active area and an element division area. The active area may be an area for acquiring an amount of light incident through a diffusion area 783 in which the microlens 710, the color filter 730, and the photodiodes are formed. The element division area may be an area for dividing each input area in the active area. In the element division area, an element division film 781 for dividing the active area and the element division area may be formed. The element division film 781 may divide input areas of green light, red light, and blue light. Photodiodes, gate electrodes 785 of transistors, and the like may be formed in the active area. The diffusion area 783 that is a photodiode area may be formed in the active area in the first substrate 610. The photodiodes may be formed by implanting impurity ions into the diffusion area 783. The gate electrodes 785 may be formed in the active area in the first substrate 610. A pattern of the gate electrodes 785 may be formed by selectively etching gate polysilicon and a gate insulating film through a patterning process using a mask. A source/drain areas 787 may be formed on the sides of the gate electrodes 785. The n-type impurity and the p-type impurity may be selectively ion-implanted to form the source/drain areas 787 of the transistors.

Interlayer insulating films may be formed on the front surfaces of the gate electrodes 785 and various metal wirings 789 may be formed on the interlayer insulating films spaced a predetermined interval apart from each other. Although it is illustrated that the metal wirings 789 are formed having three layers in the drawing, the present disclosure is not limited thereto and a plurality of metal wirings 789 may be formed.

Planarization layers may be formed on the front surfaces of the metal wirings 789 and color filters 730 of red (R), green (G), and blue (B) may be formed on the planarization layer so as to correspond to the diffusion area 783. The microlens 710 may be formed to correspond to each of the color filters 730. The microlens 710 may condense light incident from the outside. The light condensed by the microlens 710 may be incident on the photodiodes of the diffusion area 783. The photodiodes may convert an optical signal into an electrical signal, and output the same through the output unit 570.

The thermal image sensor 530 may be configured on a second substrate 630. The thermal image sensor 530 may include a microbolometer sensor 740 configured on the second substrate 630.

The second substrate 630 may be a semiconductor substrate that may include an NMOS transistor formed in a P-type semiconductor substrate and a PMOS transistor in an N-type well. The second substrate 630 may include a stacking structure that is the same as or similar to that of the first substrate 610. The second substrate 630 may include a stacking structure that is different from that of the first substrate 610. The second substrate 630 may include various circuit elements 793.

The control unit 550 and the output unit 570 may be configured on a third substrate 650. The third substrate 650 may be vertically disposed with the first substrate 610 and the second substrate 630. For example, the third substrate 650 may be disposed below the first substrate 610 and the second substrate 630.

The control unit 550 and the output unit 570 may be configured on the same substrate. Although it is illustrated that the control unit 550 and the output unit 570 are configured on the upper surface of the third substrate 650, the present disclosure is not so limited, as the control unit 550 and the output unit 570 may be formed on the upper surface and the lower surface of the third substrate 650, respectively. Alternatively, the control unit 550 and the output unit 570 may be formed on the lower surface of the third substrate 650.

The third substrate 650 may be a semiconductor substrate and may include a stacking structure that is the same as or similar to that of the first substrate 610 or second substrate 630. Alternatively, the third substrate 650 may include a stacking structure that is different from that of the first substrate 610 or second substrate 630. The third substrate 650 may include various circuit elements 791.

The color pixel sensor 510 and the thermal image sensor 530 may share the output unit 570. Color pixel data via the color pixel sensor 510 and thermal image pixel data via the thermal image sensor 530 may be output through the same output unit 570.

The first substrate 610 and the third substrate 650 may include a first via 621 that may extend through the first substrate 610 to the third substrate 650. The first via 621 may be a through silicon via (TSV). The first via 621 may vertically pass through the first substrate 610 and the third substrate 650. The first via 621 may be disposed within a hole 670 that vertically passes through the first substrate 610 and the third substrate 650.

The first via 621 may include a conductive material such as copper (Cu), aluminum (Al), silver (Ag), tin (Sn), gold (Au), or an alloy formed of a combination thereof. The first via 621 may be formed in a single layer or multilayers. In addition, an insulating layer surrounding the outside of the first via 621 may be further included. The insulating layer may include an oxide film, a nitride film, a polymer, or a combination thereof, which prevents the first via 621 from being in direct contact with the circuit elements in the first substrate 610 or the third substrate 650.

The end of the first via 621 may contact a first lower pad 750 disposed in the third substrate 650. The first lower pad 750 may be electrically connected to circuit elements 791 in the third substrate 650, and the first lower pad 750 may be formed of aluminum (Al), copper (Cu), or the like.

The first substrate 610 may further include a second via 722 formed adjacent to the first via 621, and the second via 722 may be formed in the first substrate 610. The second via 722 may be a TSV, and the second via 722 may vertically pass through the first substrate 610. The second via 722 may be disposed within the hole 670 vertically passing through the first substrate 610. The second via 722 may comprise a conductive material. Meanwhile, an insulating layer surrounding the outside of the second via 722 may be further included.

The end of the second via 722 may contact a second lower pad 770 disposed in the first substrate 610, and the second lower pad 770 may be electrically connected to circuit elements in the first substrate 610. The second via 722 may transmit an electrical signal applied from the control unit 550 to the circuit elements in the first substrate 610, through the first via 621.

A first upper pad 691 may be disposed on the first substrate 610. The first upper pad 691 may also be disposed on the upper surfaces of the first via 621 and the second via 722. The first upper pad 691 may connect the first via 621 and the second via 722 so as to transmit an electrical signal.

A driving signal of the control unit 550 may be applied to the color pixel sensor 510 through the first via 621 and the second via 722. That is, the color pixel sensor 510 formed on the first substrate 610 may receive the driving signal of the control unit 550 formed on the third substrate 650 through the first via 621 and the second via 722.

A plurality of the first vias 621 and the second vias 722 may be formed, and a number of the first via 621 and the second via 722 may correspond to a number of rows of the color pixel array 511. The plurality of the first vias 621 and the second vias 722 are formed so that driving signals may be applied to respective pixel lines.

The image sensor 410 scheme is different from a scheme for connecting the first substrate 610 and the third substrate 650 through chip-to-chip or wire bonding.

The first substrate 610 and the third substrate 650 may include a third via 623 that extends through the first substrate 610 to the third substrate 650. The third via 623 may be a TSV. The third via 623 may vertically pass through the first substrate 610 and the third substrate 650 and may be disposed within the hole 670 vertically passing through the first substrate 610 and the third substrate 650.

The third via 623 may include or be formed from a conductive material. The third via 623 may be formed in a single layer or multilayers. Meanwhile, an insulating layer surrounding the outside of the third via 623 may be further included, as described above.

The end of the third via 623 may contact a third lower pad disposed in the third substrate 650. The third lower pad may be electrically connected to circuit elements in the third substrate 650. The third lower pad may be formed of aluminum (Al), copper (Cu), or other suitable material.

The first substrate 610 may further include a fourth via formed adjacent to the third via 623. The fourth via may be formed in the first substrate 610, may be a TSV, may vertically pass through the first substrate 610, and may be disposed within the hole 670 vertically passing through the first substrate 610. The fourth via may include a conductive material. Meanwhile, an insulating layer surrounding the outside of the fourth via may be further included.

The end of the fourth via may contact a fourth lower pad disposed within the first substrate 610. The fourth lower pad may be electrically connected to circuit elements in the first substrate 610, and the fourth via may transmit color pixel signals received from the circuit elements in the first substrate 610 to the output unit 570 through the third via 623.

A second upper pad 693 may be disposed on the first substrate 610, and the second upper pad 693 may be disposed on the upper surfaces of the third via 623 and fourth via. The second upper pad 693 connects the third via 623 and the fourth via so as to transmit an electrical signal.

The color pixel signal of the color pixel sensor 510 may be transmitted to the output unit 570 through the third via 623 and the fourth via. That is, the output unit 570 formed on the third substrate 650 may receive an electrical signal of the color pixel sensor 510 formed on the first substrate 610, through the third via 623 and the fourth via.

A plurality of the third vias 623 and the fourth vias may be formed, and a number of the third via 623 and the fourth via may correspond to the number of columns of the color pixel array 511. The plurality of the third vias 623 and the fourth vias are formed so that color pixel signals may be received from respective pixel lines.

The second substrate 630 and the third substrate 650 may include a fifth via 641. The fifth via 641 may extend through the second substrate 630 to the third substrate 650, may be a TSV, and may vertically pass through the second substrate 630 and the third substrate 650. The fifth via 641 may be disposed within the hole 670 vertically passing through the second substrate 630 and the third substrate 650.

The fifth via 641 may include a conductive material. The fifth via 641 may be formed in a single layer or multilayers. Meanwhile, an insulating layer surrounding the outside of the fifth via 641 may be further included, as described above.

The end of the fifth via 641 may contact a fifth lower pad 752 disposed in the third substrate 650. The fifth lower pad 752 may be electrically connected to circuit elements 791 in the third substrate 650. The fifth lower pad 752 may be formed of aluminum (Al), copper (Cu), or other suitable material.

The second substrate 630 may further include a sixth via 742 formed adjacent to the fifth via 641. The sixth via 742 may be formed in the second substrate 630, may be a TSV, and may vertically pass through the second substrate 630. The sixth via 742 may include a conductive material. Meanwhile, an insulating layer surrounding the outside of the sixth via 742 may be further included.

The end of the sixth via 742 may contact a sixth lower pad 772 disposed in the second substrate 630. The sixth lower pad 772 may be electrically connected to circuit elements 793 in the second substrate 630. The sixth via 742 may transmit color pixel signals received from the circuit elements 793 in the second substrate 630 to the output unit 570 through the fifth via 641.

A third upper pad 695 may be disposed on the second substrate 630. The third upper pad 695 may be disposed on the upper surfaces of the fifth via 641 and the sixth via 742, and the third upper pad 695 may connect the fifth via 641 and the sixth via 742 so as to transmit an electrical signal.

A driving signal of the control unit 550 may be transmitted to the thermal image sensor 530 through the fifth via 641 and the sixth via 742. That is, the thermal image sensor 530 formed on the second substrate 630 may receive the driving signal of the control unit 550 formed on the third substrate 650 through the fifth via 641 and the sixth via 742.

A plurality of the fifth vias 641 and the sixth vias 742 may be formed, and a number of fifth via 641 and the sixth via 742 may correspond to the number of rows of the thermal image pixel array 531. The plurality of the fifth vias 641 and the sixth vias 742 are formed so that driving signals may be applied to respective pixel lines.

Although it is illustrated in the FIGs. that there are two control units of the first control unit 552 and the second control unit 553, the present disclosure is not so limited thereto. There may be one control unit and a driving signal of the control unit may be received through the fifth via 641 and the sixth via 742.

The image sensor 410 scheme is different from a scheme of connecting the second substrate 640 and the third substrate 650 through chip-to-chip or wire bonding.

The second substrate 630 and the third substrate 650 may include a seventh via 643. The seventh via 643 may extend through the second substrate 630 to the third substrate 650, may be a TSV, and may vertically pass through the second substrate 630 and the third substrate 650. The seventh via 643 may be disposed within the hole 670 vertically passing through the second substrate 630 and the third substrate 650.

The seventh via 643 may include a conductive material. The seventh via 643 may be formed in a single layer or multilayers. Meanwhile, an insulating layer surrounding the outside of the seventh via 643 may be further included.

The end of the seventh via 643 may contact a seventh lower pad disposed in the third substrate 650. The seventh lower pad may be electrically connected to circuit elements in the third substrate 650. The seventh lower pad may be formed of aluminum (Al), copper (Cu), or other suitable material.

The second substrate 630 may further include an eighth via formed adjacent to the seventh via 643. The eighth via may be formed in the second substrate 630, may be a TSV, and may vertically pass through the second substrate 630. The eighth via may include a conductive material. Meanwhile, an insulating layer surrounding the outside of the eighth via may be further included.

The end of the eighth via may contact an eighth lower pad disposed in the second substrate 630. The eighth lower pad may be electrically connected to circuit elements in the second substrate 630. The eighth via may transmit color pixel signals received from the circuit elements in the second substrate 630 to the output unit 570 through the seventh via 643.

A fourth upper pad 697 may be disposed on the second substrate 630. The fourth upper pad 697 may be disposed on the upper surfaces of the seventh via 643 and the eighth via. The fourth upper pad 697 may connect the seventh via 643 and the eighth via so as to transmit an electrical signal.

A thermal image pixel signal of the thermal image sensor 530 may be transmitted to the output 570 through the seventh via 643 and the eighth via. That is, the output unit 570 formed on the third substrate 650 may receive an electrical signal of the thermal image sensor 530 formed on the second substrate 630 through the seventh via 643 and the eighth via.

A plurality of the seventh vias 643 and the eighth vias may be formed, and a number of the seventh via 643 and the eighth via may correspond to the number of columns of the thermal image pixel array 531. The plurality of the seventh vias 643 and the eighth vias are formed so that thermal image pixel signals may be received from respective pixel lines.

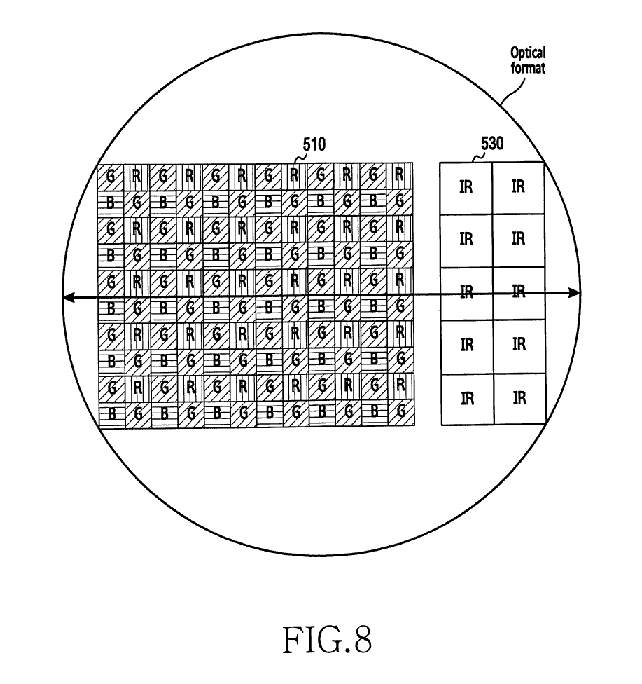

FIG. 8 is diagram of an image sensor 410, according to an embodiment of the present disclosure.

As illustrated in FIG. 8, the color pixel sensor 510 and the thermal image sensor 530 may be located within an identical optical format. The optical format may refer to an area on which a lens for receiving an image, in the camera module 401 having the image sensor 410, may focus. The electronic device 101 may acquire a color image through the color pixel sensor 510 and a thermal image through the thermal image sensor 530, using one lens system of the camera module 401. The thermal image sensor 530 may be disposed at the edge within an identical optical format. That is, the thermal image sensor 530 may be disposed on the side surface of the color pixel sensor 510 within the identical optical format. The thermal image sensor 530 may be disposed in an area smaller than that of the color pixel sensor 510. For example, the thermal image sensor 530 may be disposed in rows, the number of which is smaller than that of the color pixel sensor 510. Alternatively, the thermal image sensor 530 may be disposed in columns, the number of which is smaller than that of the color pixel sensor 510. Alternatively, the thermal image sensor 530 may be disposed in an area smaller than that of the color pixel sensor 510. Alternatively, the thermal image sensor 530 may be disposed at a size smaller than that of the color pixel sensor 510.

The electronic device 101 may include a display 430, an image sensor 410 including a color pixel sensor 510; a thermal image sensor 530, and a processor 440, wherein the processor 440 is configured to acquire a first image 1011 of a subject using the color pixel sensor 510, acquire a second image 1013 of the subject using the thermal image sensor 530, and replace a part of the area of the first image 1011 with the second image 1013 so as to output the same through the display 430.

In the electronic device 101, the image sensor 410 may be configured to include at least one thermal image sensor 530.

In the electronic device 101, the color pixel sensor 510 may be configured on a first substrate 610, and the thermal image sensor 530 may be configured on a second substrate 630.

In the electronic device 101, the processor 440 may be configured to acquire color information corresponding to the color pixel sensor 510 and thermal image information corresponding to the thermal image sensor 530 at the same time.

In the electronic device 101, the processor 440 may be configured to change a part of the area of the first image 1011 using at least a part of the second image 1013, at least based on a motion of the electronic device 101.

In the electronic device 101, the image sensor 410 may further include a control unit 550 configured on a third substrate 650, and the control unit 550 may control the color pixel sensor 510 and the thermal image sensor 530 at the same time.

In the electronic device 101, the image sensor 410 may further include an output unit 570 configured on the third substrate 650, and the color pixel sensor 510 and the thermal image sensor 530 may output a signal to the output unit 570.

In the electronic device 101, the third substrate 650 may be vertically disposed with the first substrate 610 and the second substrate 630.

In the electronic device 101, the third substrate 650 may be electrically connected with the first substrate 610 and the second substrate 630 via a TSV.

The electronic device 101 further includes a first via formed on the first substrate 610 and the third substrate 650, and a second via formed on the first substrate 610, wherein the control unit 550 may transmit a signal to the color pixel sensor 510 and the thermal image sensor 530 through the first via and the second via.

The electronic device 101 further includes, a third via formed on the first substrate 610 and the third substrate 650, and a fourth via formed on the first substrate 610, wherein the color pixel sensor 510 or the thermal image sensor 530 may output a signal to the output unit 570 through the third via and the fourth via.

In the electronic device 101, the image sensor 410 may be provided to a camera module 401 including a lens, and the color pixel sensor 510 and the thermal image sensor 530 may be disposed in the same area in an optical format that is an area on which the lens focuses.

In the electronic device 101, the second image 1013 extended on the first image 1011 according to the moving direction of the electronic device 101 may be output.

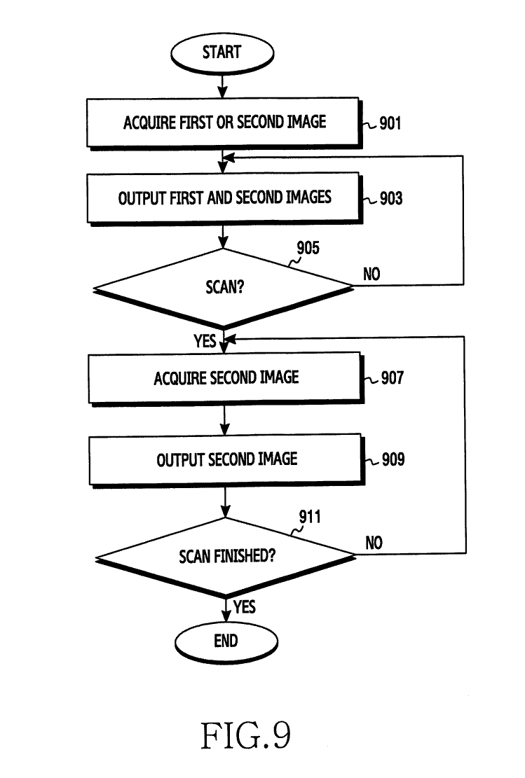

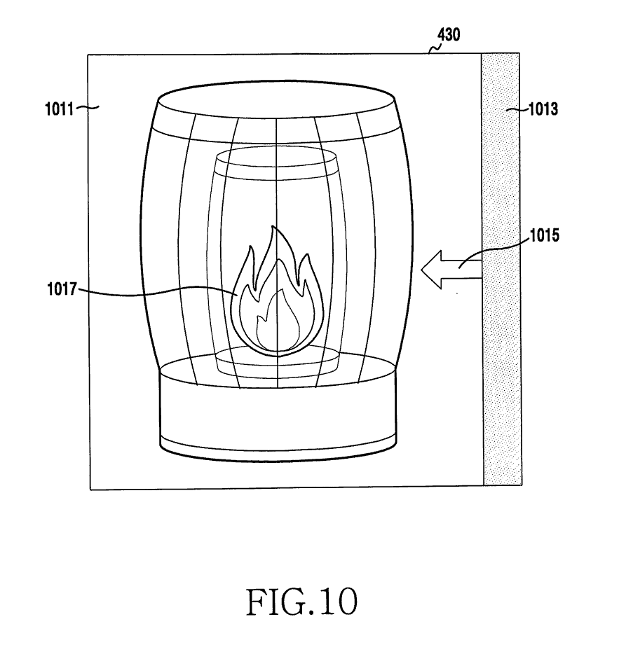

FIG. 9 is a flowchart of a method of use of an electronic device 101, and FIG. 10 to FIG. 12 are diagrams of an image acquired through an electronic device 101, according to an embodiment of the present disclosure.

As illustrated in FIG. 9, an electronic device 101 (e.g., a processor 440) may acquire first and second images 1011, 1013, in step 901. The processor 440 may acquire the first image 1011 and second image 1013 of a subject. The processor 440 may acquire the first image 1011 using color information corresponding to the color pixel sensor 510. The first image 1011 may be a color image. The processor 440 may acquire the second image 1013 using thermal image information corresponding to the thermal image sensor 530. The second image 1013 may be a thermal image.

The processor 440 may output the first image 1011 or the second image 1013, in step 903. As illustrated in FIG. 10, the processor 440 may process the first image 1011 and the second image 1013 so as to display the same on the electronic device 101 (e.g., a display 430). Meanwhile, as described hereinbefore, since the color pixel sensor 510 and the thermal image sensor 530 are located under an identical optical format, the second image 1013 that is a thermal image may be output at the edge of the first image 1011 that is a color image. For example, the second image 1013 may be output to the location corresponding to a location at which the thermal image sensor 530 is disposed in the image sensor 410. Therefore, a thermal image of a part of the subject 1017 may be output.

The processor 440 may perform a scanning request operation while displaying the first image 1011 or the second image 1013 on the display 430. The processor 440 may display an icon 1015 for a scan request in order to provide a thermal image of the remaining part of the subject 1017 to the display 430. The electronic device 101 may provide a user with a notification of a scan direction by displaying the icon 1015 on the display 430. For example, the icon 1015 may be an arrow shape indicating the scan direction. The processor 440 may request a scan such that the thermal image sensor 530 may detect the remaining part of the corresponding subject 1017.

The processor 440 may determine whether scanning is performed, in step 905. The processor 440 may determine whether scanning is performed, through the motion sensor 420. The motion sensor 420 may sense a motion for scanning, and the processor 440 may continuously display the first and second images 1011, 1013 on the display 430 when no motion is sensed.

The processor 440 may acquire the extended second image 1013 through scanning, in step 907. The processor 440 may perform scanning through a user. Since the thermal image pixel array 531 constituting the thermal image sensor 530 is smaller than the color pixel array 511 constituting the color pixel sensor 510, scanning may be performed by the user in order to acquire thermal images of all parts of the subject 1017. The electronic device 101 may be moved by the user to acquire thermal images of all parts of the subject 1017. For example, the user may move the electronic device 101 in a direction in which the first image 1011 that is a color image is replaced with the thermal image.

As processor 440 moves by the user, the processor 440 may extend the second image 1013 from a part of the subject 1017 to all parts of the subject 1017. The processor 440 may continuously acquire the second image 1013 while the user is performing scanning. The processor 440 may acquire a thermal image corresponding to an area in which scanning of the subject 1017 has been performed, using the thermal image sensor 530.

The processor 440 may output the second image 1013, in step 909. The processor 440 may process the second image 1013 acquired by scanning the subject 1017 by the user, so as to display the same on the display 430. The processor 440 may output the second image 1013 extended on the first image 1011 while displaying the first image 1011.

The processor 440 may acquire motion information through the motion sensor 420, in step 909. The processor 440 may perform alignment using the first image 1011, the second image 1013 acquired through scanning, and information sensed by the motion sensor 420. For example, the first image 1011 and the second image 1013 may be aligned by using a motion sensed by the motion sensor 420. The first image 1011 and the second image 1013 may be matched using the motion information and the contour of the subject acquired in the first image 1011.

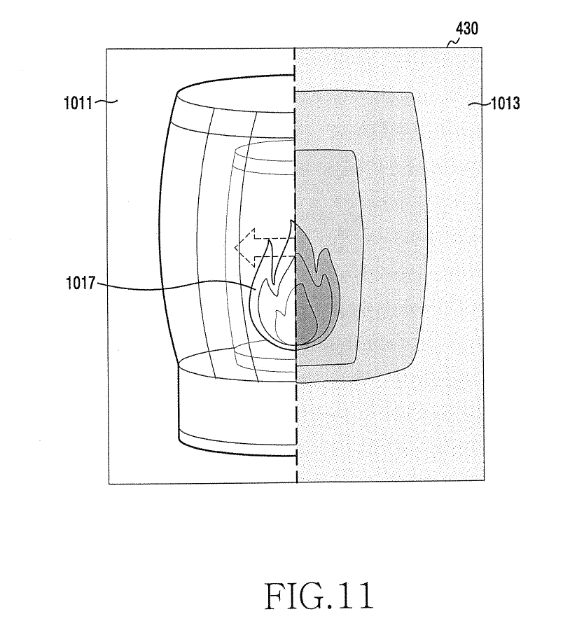

For example, as illustrated in FIG. 11, when scanning of the subject 1017 is partially performed, the processor 440 may display the first image 1011 and the second image 1013 together on the display 430. The processor 440 may replace a part of the area of the first image 1011 in FIG. 10 with the second image 1013, and display the same on the display 1013. The processor 440 may display, on the display 430, the second image 1013 corresponding to the area in which scanning has been performed, instead of the first image 1011. As scanning progresses, the first image 1011 may be gradually replaced with the second image 1013 that is a thermal image. Therefore, the display 430 may display the second image 1013 extended on the first image 1011 according the moving direction of the electronic device 101.

The processor 440 may determine whether the scan is finished, in step 911. The processor 440 may determine whether the scan is finished, through the motion sensor 420. The motion sensor 420 may sense a motion for scanning, and the processor 440 may determine that the scan is not finished when a motion is sensed. Alternatively, the processor 440 may determine that the scan is not finished when only a part of the first image 1011 is replaced with the second image 1013. For example, the processor 440 may determine that the scan is not finished when it is determined that not all parts of the first image 1011 are replaced with the second image 1013.

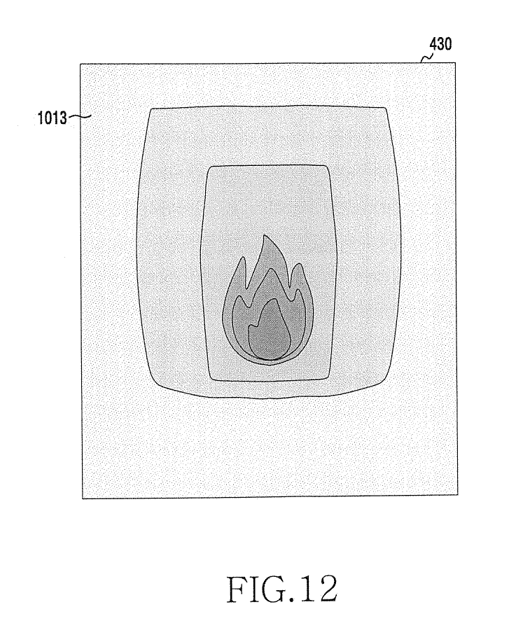

When it is determined that the scan is not finished, the processor 440 may return to operation 907 and continuously acquire the second image 1013. For example, the extended second image 1013 may be acquired by scanning the remaining area of the subject 1017. All parts of the first image 1011 may be replaced with the second image 1013 that is a thermal image through continuous scanning of the subject 1017, as illustrated in FIG. 12.

The processor 440 may determine that the scan is finished when no motion is sensed through the motion sensor 420 for a predetermined time, so as to terminate an operation. Alternatively, the processor 440 may determine that the scan is finished when all parts of the first image 1011 are replaced with the second image 1013, so as to terminate an operation even a motion is sensed.

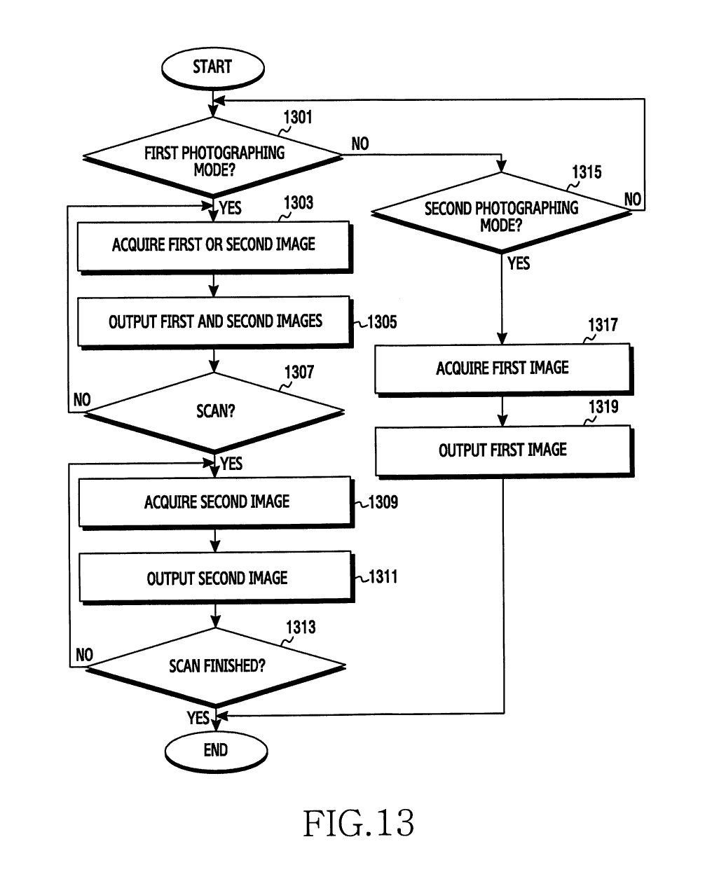

FIG. 13 is a flowchart of a method of use of an electronic device 101 according to various embodiments.

The electronic device 101 (e.g., a processor 440) may determine a photographing mode, in step 1301. The processor 440 may determine whether a mode is a first photographing mode. The processor 440 may determine a photographing mode by a selection of a user. The processor 440 may acquire an image according to the determined photographing mode.

The processor 440 may perform, in step 903, an operation of the first photographing mode when it is determined, in step 1301, that the mode is the first photographing mode. The first photographing mode may be a mode for photographing using both the color pixel sensor 510 and the thermal image sensor 530. The first photographing mode may be a photographing mode for acquiring a color image and a thermal image. The first photographing mode may correspond to in the method described with respect to FIG. 9. Steps 1303, 1305, 1307, 1309, 1311, and 1313 may correspond to operations 901, 903, 905, 907, 909, and 911, respectively, and a detailed description thereof is omitted.

The processor 440 may determine, in step 1301, whether a mode is a second photographing mode when it is determined, in step 1315, that the mode is not the first photographing mode. The second photographing mode may be a mode for photographing using only the color pixel sensor 510.

The processor 440 may acquire the first image 1011 when it is determined that the mode is the second photographing mode, in step 1317. The first image 1011 may be a color image of the subject. The processor 440 may acquire only a color image of the subject according to the second photographing mode.

The processor 440 may output the acquired first image 1011, in step 1319. The processor 440 may process the first image 1011 so as to display the same on the display 430. The processor 440 may process only a color image of the subject according to the second photographing mode, so as to display the same on the display 430.

A method of use of an electronic device 101 including a display 430, a color pixel sensor 510, a thermal image sensor 530, and a processor 440 may include acquiring a first image 1011 of a subject 1017 using a color pixel sensor 510, acquiring a second image 1013 of the subject using the thermal image sensor 530, and replacing a part of the area of the first image 1011 with the second image 1013, thereby outputting the same through the display 430.

The method may include acquiring of the second image 1013 may include acquiring color information corresponding to the color pixel sensor 510 and thermal image information corresponding to the thermal image sensor 530 at the same time.

The method may include outputting of the part of the area of the first image, replaced with the second image may include changing a part of the first image 1011 using at least a part of the second image 1013, at least based on a motion of the electronic device 101.

The method may include outputting the part of the area of the first image, replaced with the second image may include extending the second image 1013 and outputting the same.

The method may include outputting of the part of the area of the first image, replaced with the second image may further include displaying the first image 1011, the second image 1013, and the scan direction 1015 of the subject.

The method may include acquiring of the second image 1013 may include acquiring a thermal image of the subject using the thermal image sensor 530.

The method may include acquiring of the second image 1013 may include acquiring a thermal image of the subject 1017 according to the direction of scanning the subject 1017.

The method may include outputting of the part of the area of the first image, replaced with the second image may further include acquiring motion information of scanning the subject 1017, and displaying the first image 1011 and the second image 1013 by matching the same using the motion information.

The features, structures, effects described herein are included in at least one embodiment of the present disclosure, and are not necessarily limited to only one embodiment. Furthermore, the features, structures, effects illustrated in each of the embodiments can be implemented in the other embodiments through combination and modification of the same, by those skilled in the art to which the embodiments belong. Therefore, it is to be understood that contents relating to such combinations and modifications are included in the range of the present disclosure.

In addition, although the present disclosure has provided descriptions particularly with reference to embodiments thereof, it should be clearly understood that the embodiments are merely examples and do not limit the present disclosure. Further, those skilled in the art to which the embodiments belong may understand that various modifications and applications which are not illustrated hereinbefore are also possible within the range of the essential characteristics of the present embodiments. For example, each component specifically shown in the embodiments may be modified to be implemented. In addition, it is to be understood that differences relating to the modifications and applications are included within the range of the present disclosure, as defined by the appended claims.

An electronic device of the present disclosure may provide a thermal image without having to use a separate module for providing the thermal image, as with conventional electronic devices. In addition, an electronic device of the present disclosure may provide both a color image and a thermal image through an image sensor.

An electronic device of the present disclosure may improve the transmission speed of an electrical signal through a stacking structure of the image sensor. Therefore, the acquisition speed or processing speed of a color image or a thermal image may be improved.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device comprising:
a display;
an image sensor comprising a color pixel sensor;
a thermal image sensor; and
a processor configured to acquire a first image of a subject using the color pixel sensor, acquire a second image of the subject using the thermal image sensor, and replace a part of an area of the first image with the second image thereby creating an modified first image that is output through the display.

2. The electronic device of claim 1, wherein the image sensor further comprises the thermal image sensor.

3. The electronic device of claim 1, wherein the color pixel sensor is provided on a first substrate and the thermal image sensor is provided on a second substrate.

4. The electronic device of claim 1, wherein the processor is further configured to acquire color information corresponding to the color pixel sensor and thermal image information corresponding to the thermal image sensor at the same time.

5. The electronic device of claim 1, wherein the processor is further configured to change the part of the area of the first image using at least a part of the second image, at least based on a motion of the electronic device.

6. The electronic device of claim 3, wherein the image sensor further comprises a control unit provided on a third substrate, wherein the control unit is configured to control the color pixel sensor and the thermal image sensor at the same time.

7. The electronic device of claim 6, wherein the image sensor further comprises an output unit provided on the third substrate, wherein the color pixel sensor and the thermal image sensor are configured to output a signal to the output unit.

8. The electronic device of claim 7, wherein the third substrate is oriented vertically with respect to the first substrate and the second substrate.

9. The electronic device of claim 8, wherein the third substrate is electrically connected with the first substrate and the second substrate through a through silicon via (TSV).

10. The electronic device of claim 6, further comprising:
a first via formed on the first substrate and the third substrate; and
a second via formed on the first substrate, wherein the control unit is further configured to transmit a signal to one of the color pixel sensor and the thermal image sensor through the first via and the second via.

11. The electronic device of claim 10, further comprising:
a third via formed on the first substrate and the third substrate; and
a fourth via formed on the first substrate, wherein one of the color pixel sensor and the thermal image sensor are configured to output a signal to the output unit through the third via and the fourth via.

12. The electronic device of claim 1, wherein the image sensor is operably connected to a camera module comprising a lens, and the color pixel sensor and the thermal image sensor are disposed in an identical area in an optical format that is an area on which the lens focuses.

13. The electronic device of claim 1, wherein the part replaced with the second image of the modified first image is extended according to the moving direction of the electronic device.

14. A method of an electronic device that comprises a display, a color pixel sensor, a thermal image sensor, and a processor, the method comprising:
acquiring a first image of a subject using the color pixel sensor;
acquiring a second image of the subject using the thermal image sensor; and
replacing a part of an area of the first image with the second image thereby creating a modified first image and outputting the same through the display.

15. The method of claim 14, wherein acquiring the second image comprises acquiring color information corresponding to the color pixel sensor and thermal image information corresponding to the thermal image sensor at the same time.

16. The method of claim 14, wherein outputting the modified first image comprises changing the part of the area of the first image using at least a part of the second image, at least based on a motion of the electronic device.

17. The method of claim 14, wherein outputting the modified first image comprises the part replaced with the second imaged is extended according to the moving direction of the electronic device.

18. The method of claim 14, wherein outputting the modified first image comprises displaying the first image, the second image, and a scan direction of the subject.

19. The method of claim 14, wherein acquiring the second image comprises acquiring a thermal image of the subject using the thermal image sensor.

20. The method of claim 14, wherein outputting the modified first image comprises acquiring motion information of scanning the subject, wherein the first image and the second image are matched and displayed using the motion information.
